(19) United States
(12) Patent Application Publication
(10) Pub. No.: US 2021/0055461 A1
(43) Pub. Date: Feb. 25, 2021

(54) CAMERA DEVICE

(71) Applicant: Qisda Corporation, Taoyuan City (TW)

(72) Inventor: Wei-Jin CHEN, Taoyuan City (TW)

(73) Assignee: Qisda Corporation, Taoyuan City (TW)

(21) Appl. No.: 16/986,041

(22) Filed: Aug. 5, 2020

(30) Foreign Application Priority Data
Aug. 20, 2019 (CN) 201910766913.7

(51) Int. Cl. G02B 5/20; G02B 1/11; G03B 11/00

(52) U.S. Cl. CPC G02B 5/205; H04N 5/2252; G03B 11/00; G02B 1/11

(57) ABSTRACT

The present invention provides a camera device comprising a housing, an image sensing unit, an optical unit and a neutral density filter assembly. The housing has a light entrance. The image sensing unit is disposed in the housing. The optical unit is disposed between the light entrance and the image sensing unit. Light enters the housing through the light entrance and forms an image at the image sensing unit via the optical unit. The neutral density filter assembly is disposed between the light entrance and the optical unit and includes a first neutral density filter layer and a second neutral density filter layer. The first neutral density filter layer and the second neutral density filter layer are disposed along the direction in which the light is transmitted.

### BACKGROUND OF THE INVENTION

### 1. Field of the Invention

The present disclosure relates to a camera device, in particular, a camera device having a neutral density filter.

### 2. Description of the Prior Art

In current art, camera devices usually conduct dimming by using neutral density filters with low transmittance so as to prevent light that is too strong from destroying image sensing chips or other light sensitive optical elements in the camera devices. However, due to the partially penetrable property of the neutral density filters, when a reflection path is formed between an optical unit (such as a convex lens) and the neutral density filter in the camera device to make the incident light reflected many times through the neutral density filter before reaching the image sensing chip, it is easy to have the light concentrated locally in the image detected by the image sensing chip, resulting in an unclear detected image.

### SUMMARY OF THE INVENTION

As mentioned above, the present disclosure provides a camera device, using two or more neutral density filters to reduce the problem of local concentration of light in an image.

The embodiment of the present disclosure provides a camera device including a housing, an image sensing unit, an optical unit and a neutral density filter assembly. The housing has a light entrance, and the image sensing unit is disposed in the housing. The optical unit is disposed between the light entrance and the image sensing unit. Light enters the housing through the light entrance and forms an image at the image sensing unit via the optical unit. The neutral density filter assembly is disposed between the light entrance and the optical unit and includes a first neutral density filter layer and a second neutral density filter layer. The first neutral density filter layer and the second neutral density filter layer are disposed along the direction in which the light is transmitted.

In order to further understand the features and technical contents of the present invention, please refer to the following descriptions and FIGs related to the present invention; however, provided FIGs are merely used for reference and description and never limit the scope of the present invention.

### BRIEF DESCRIPTION OF THE DRAWINGS

FIG. 1 illustrates a diagram of a camera device in an embodiment of the present disclosure.

FIG. 2A illustrates a neutral density filter assembly in an embodiment of the present disclosure.

FIG. 2B illustrates a neutral density filter assembly in another embodiment of the present disclosure.

FIG. 2C illustrates a neutral density filter in another embodiment of the present disclosure.

FIG. 2D illustrates a neutral density filter in another embodiment of the present disclosure.

FIG. 3 illustrates a diagram of the camera device in another embodiment of the present disclosure.

### DETAILED DESCRIPTION OF THE PREFERRED EMBODIMENT

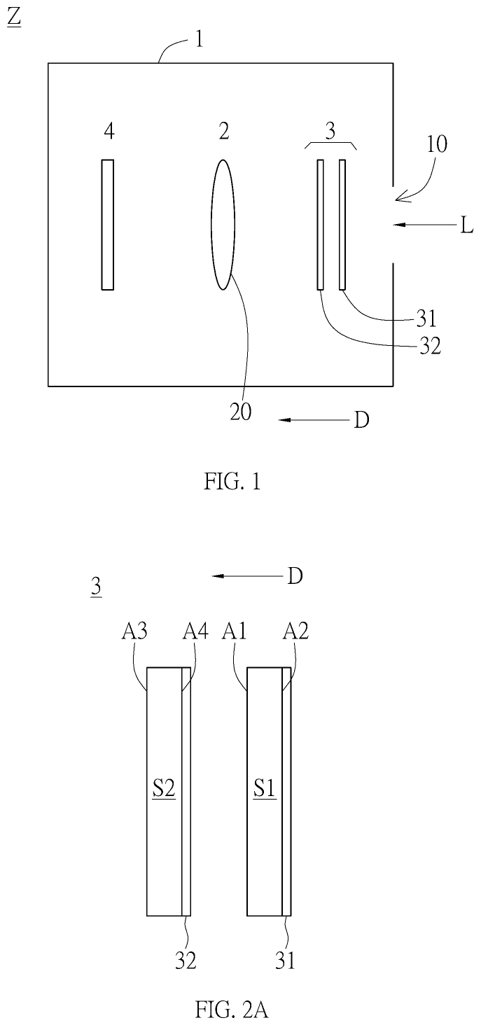

The camera device according to the present invention will be described in detail below through embodiments and with reference to FIG. 1 to FIG. 3. A person having ordinary skill in the art may understand the advantages and effects of the present disclosure through the contents disclosed in the present specification. However, the contents shown in the following sentences never limit the scope of the present disclosure. Without departing from the conception principles of the present invention, a person having ordinary skill in the present art may realize the present disclosure through other embodiments based on different views and applications. In addition, it should be noted that, in the attached FIGs, for the purpose of clarification, elements are not illustrated based on the actual sizes. In addition, even though the terms such as “first”, “second”, “third” may be used to describe an element, but these elements are not limited by such terms. Such terms are merely used to differentiate elements.

Firstly, please refer to FIG. 1. The present disclosure provides a camera device Z which includes a housing 1, an image sensing unit 4, an optical unit 2, and a neutral density filter assembly 3. The housing 1 has a light entrance 10. The image sensing unit 4 is disposed in the housing 1, configured to detect a light L entering the housing 1; the optical unit 2 is disposed between the light entrance 10 and the image sensing unit 4 so as to make the light L form an image at the image sensing unit 4. The neutral density filter assembly 3 is disposed between the light entrance 10 and the optical unit 2 so as to filter the light L fractionally. The neutral density filter assembly 3 includes a first neutral density filter layer 31 and a second neutral density filter layer 32, wherein the first neutral density filter layer 31 and the second neutral density filter layer 32 are disposed along a direction D in which the light is transmitted.

Furthermore, based on the wavelength of light detected by the image sensing unit 4, the camera device Z, for example, may be an ambient light camera or infrared camera, and the present disclosure is not limited thereto. In the actual application, a display screen, for example, may be disposed on the side of the housing 1 opposite to the light entrance 10 so as to display an image detected by the image sensing unit 4 in the present embodiment; otherwise, in another embodiment, the image sensing unit 4 may be connected to an arithmetic device (such as a notebook PC) so as to display an image detected by the image sensing unit 4 in the arithmetic device. The present disclosure is not limited to the camera device illustrated in FIG. 1.

In the embodiment of the present disclosure, the neutral density filter assembly 3 is configured to include the first neutral density filter layer 31, and the second neutral density filter layer 32 so as to filter the light L separately and decrease the intensity of the light L on the optical unit 2 and the second neutral density filter layer 32 so that less light is reflected and the problem of local concentration of light on the image captured by the image sensing unit 4 may be solved. Specifically, in current camera devices, at least a portion of the light will be reflected by an incident surface in the optical unit when the light enters the optical unit after going through the neutral density filter layers, wherein the amount of reflected light is determined by the material of the optical unit and the curvature of the incident surface. Since the neutral density filter layers merely allow a portion of the light to go through, the light reflected by the incident surface will be reflected by the neutral density filter layer again to go back to the optical unit, resulting in the sensor receiving an extra amount of the light. In particular, when the neutral density filter has a low light transmittance, most of the light reflected from the incident surface 20 are reflected again to go back to the incident surface 20, resulting in an increase of the amount of light received by a portion of the image sensing unit 4 to cause a portion of the image to be too bright. However, the embodiment of the present disclosure uses two neutral density filter layers, that is, the first neutral density filter layer 31 and the second neutral density filter layer 32, so as to allow the neutral density filter assembly 3 to have a lower effective light transmittance and lessen the current problem that light is too concentrated locally when the light transmittance is low.

In the present embodiment, the first neutral density filter layer 31 has a light transmittance equal to or greater than 12%; the second neutral density filter layer 32 has a light transmittance equal to or larger than 12%; and the neutral density filter assembly 3 has an effective light transmittance smaller than 15%. Specifically, when a plurality of neutral density filter layers are used in the neutral density filter assembly 3 wherein each of the neutral density filter layers has a light transmittance which does not cause a localized concentration of light in the image, or causes a localized concentration of light in the image within a tolerated range (in the present embodiment, neutral density filter layers having light transmittance equal to or greater than 12% are used; however the present disclosure is not limited thereto), then the effective light transmittance of the neutral density filter assembly 3 can achieve the predetermined low light transmittance (in the present embodiment, a low light transmittance means a light transmittance lower than 15%, but it is not limited thereto), and it is possible to avoid the problem of the light being locally concentrated in the image sensing unit 4 due to the neutral density filter having a low light transmittance in the current art.

In a preferred embodiment, the first neutral density filter layer 31 and the second neutral density filter layer 32 may have different light transmittances so that the camera device Z can have a plurality of light transmittances to be used in combination. For example, in an embodiment, a first neutral density filter layer 31 having a 15% light transmittance and a second neutral density filter layer 32 having a 14% light transmittance may form a neutral density filter assembly 3 having an effective light transmittance of approximately 2%. When it is used in combination with a suitable optical film replacement mechanism, it allows the camera device Z to have the light transmittances of 15%, 14% and 2% available. The present disclosure is not limited thereto. In another embodiment, the neutral density filter assembly 3 may merely have the function of being used alone. In addition, an optical film replacement mechanism is an ordinary skill in the field of the present art. People skilled in the art may design it based on the actual application conditions.

In another preferred embodiment, the light transmittance of the second neutral density filter layer 32 is greater than that of the first neutral density filter layer 31. Therefore, when the light L is reflected from the incident surface 20 to be projected to the second neutral density filter layer 32, the second neutral density filter layer 32 having a higher light transmittance than the first neutral density filter layer 31 may allow a greater amount of the light L to go through so as to decrease the likelihood of the light L being reflected back to the optical unit 2 Then the problem of having an uneven amount of light in the image may be solved.

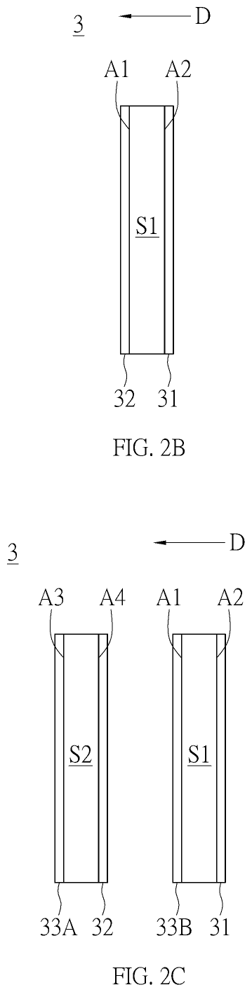

Please refer to FIG. 2A. In an actual application, the neutral density filter assembly 3 has a first substrate S1 and a second substrate S2, wherein the first substrate S1 and the second substrate S2 are arranged along a direction D in which the light is transmitted. The first substrate S1 has a first surface A1 facing the optical unit and a second surface A2 opposite to the first surface A1. The second substrate S2 has a third surface A3 facing the optical unit and a fourth surface A4 opposite to the third surface A3. The first neutral density filter layer 31 is disposed on either the first surface A1 or the second surface A2, and the second neutral density filter layer 32 is disposed on either the third surface A3 or the fourth surface A4. In the embodiment illustrated in FIG. 2A, the first neutral density filter layer 31 is disposed on the second surface A2, and the second neutral density filter layer 32 is disposed on the fourth surface A4, for example; however, the present disclosure is not limited thereto.

Please refer to FIG. 2B. In another embodiment, the neutral density filter assembly 3 may merely have a substrate. Specifically, in the embodiment illustrated in FIG. 2B, the neutral density filter assembly 3 has a first substrate S1, and the first substrate S1 has a first surface A1 facing the optical unit and a second surface A2 opposite to the first surface A1, wherein the first neutral density filter layer 31 and the second neutral density filter layer 32 are respectively disposed on the second surface A2 and the first surface A1 of the first substrate S1.

Please refer to FIG. 2C. The neutral density filter assembly 3 in the present embodiment further includes anti-reflective layers (33A, and 33B) respectively disposed on the third surface A3 of the second substrate S2 and the first surface A1 of the first substrate S1. Specifically, disposing the anti-reflective layers (33A, and 33B) respectively on the third surface A3 and the first surface A1 may decrease the reflectance of the light reflected from the incident surface 20 on the first surface A1 and the third surface A3 so as to decrease the likelihood of the image sensing unit 4 receiving too much light locally. The embodiment illustrated in FIG. 2C has two anti-reflective layers (33A, and 33B); however, the present disclosure is not limited thereto. For example, in another variant embodiment, the neutral density filter assembly 3 may merely have one anti-reflective layer disposed on the first surface A1 or the third surface A3.

Please refer to FIG. 2D. In another embodiment of the present disclosure, the neutral density filter assembly 3 may further include diamond-like carbon films (34A, and 34B) disposed on the third surface A3 of the second substrate S2 and the first surface A1 of the first substrate S1. In an actual application, since the diamond-like carbon films have deeper colors and lower surface reflectance, therefore, in addition to the advantage of easy assembly, the reflectance of the light reflected from the incident surface 20 on the first surface A1 or the third surface A3 may also be decreased so as to decrease the likelihood of the image sensing unit 4 receiving too much light locally. Similarly, the embodiment illustrated in FIG. 2D has two diamond-like carbon films (34A, and 34B); however, the present disclosure is not limited thereto. In another embodiment, the diamond-like carbon film may merely be disposed on the third surface A3, or, in another embodiment, the diamond-like carbon film may be disposed on the third surface A3, and the anti-reflective layer may be disposed on the first surface A1.

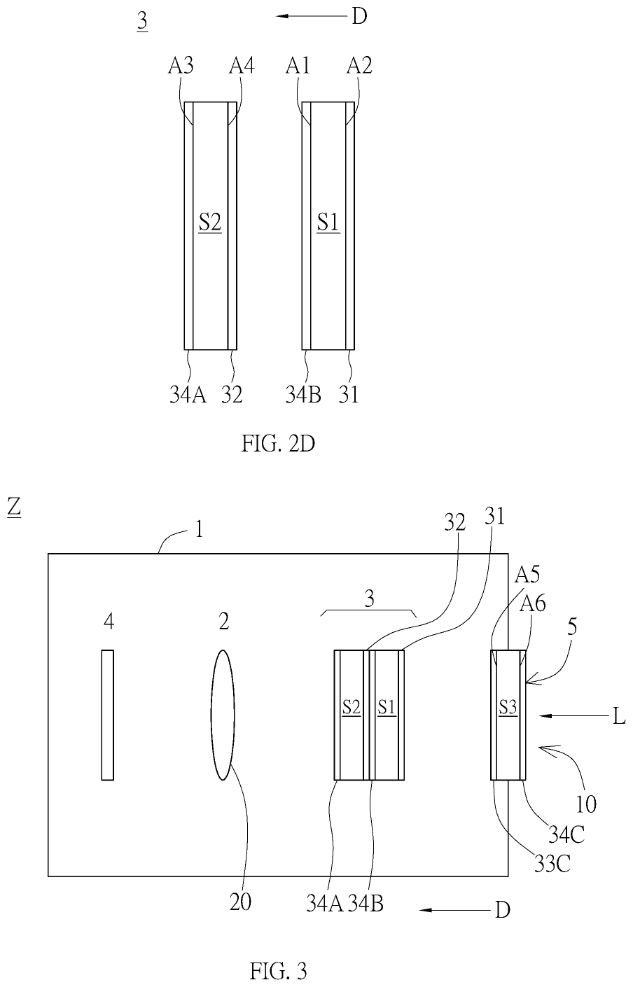

Please refer to FIG. 3. In an embodiment of the present disclosure, the camera device Z may have a protection unit 5 disposed on the light entrance 10 so as to protect the optical unit in the housing 1. The protection unit 5 has a fifth surface A5 facing the optical unit 2 and a sixth surface A6 opposite to the optical unit 2, and the protection unit 5 has an anti-reflective layer 33C on the fifth surface A5 so as to further decrease the likelihood of the light in the housing 1 being reflected back to the image sensing unit 4 to prevent the image sensing unit 4 from receiving too much light locally.

Furthermore, in the embodiment illustrated in FIG. 3, the protection unit 5 has a diamond-like carbon film 34C on the sixth surface A6. Since the sixth surface A6 of the protection unit 5 is outside of the housing, the high hardness of the diamond-like carbon film 34C can achieve a protective effect for the protection unit 5. However, the present disclosure is not limited thereto.

In the aforementioned embodiments, the incident surface 20 of the optical unit 2 is a curved surface convex to the light entrance 10, and the optical unit 2 is a focusing lens. However, the present disclosure is not limited there to. For example, in a variant embodiment, the incident surface 20 directly opposite to the third surface A3 of the second substrate S2 may be a flat surface or a concaved curved surface. In addition, in another embodiment, the optical unit 2, for example, may be a relay lens, and may further have focusing lens sets configured to project the light L on the image sensing unit 4 between the relay lens and the image sensing unit 4.

In addition, in the embodiment of FIG. 3, the first substrate S1 holding the first neutral density filter layer 31 and the second substrate S2 holding the second neutral density filter layer 32 are attached to each other; however, the present disclosure is not limited thereto. In another embodiment, for example, the first substrate S1 and the second substrate S2 may be used alone or in combination. A gap exists between the first substrate S1 and the second substrate S2, wherein the size of the gap may be determined based on, for example, the effective light transmittance predetermined by the neutral density filter assembly 3. In addition, two neutral density filters are used in the aforementioned embodiment as an example; however, the present disclosure is not limited thereto. In another embodiment, the neutral density filter assembly 3 may have more than three neutral density filters.

In summary, the camera device provided by the present embodiment may lessen the problem of local unevenness of light in the image detected by the camera device through the technical means of “disposing a neutral density filter assembly between a light entrance and an optical unit”, “disposing the optical unit between the light entrance and an image sensing unit”, and “having the neutral density filter assembly to include a first neutral density filter and a second neutral density filter”.

The aforementioned descriptions represent merely the exemplary embodiments of the present embodiment and are not meant to limit the scope of the present disclosure. Various equivalent changes and alternations based on the specification and the FIGs of the present disclosure are embraced by the scope of the present disclosure.

What is claimed is:

1. A camera device, comprising:
a housing having a light entrance;
an image sensing unit disposed in the housing;
an optical unit disposed between the light entrance and the image sensing unit, a light entering the housing through the light entrance to form an image at the image sensing unit via the optical unit; and
a neutral density filter assembly disposed between the light entrance and the optical unit, the neutral density filter assembly comprising a first neutral density filter layer and a second neutral density filter layer, the first neutral density filter layer and the second neutral density filter layer arranged along a direction in which the light is transmitted.

2. The camera device according to claim 1, wherein the first neutral density filter layer and the second neutral density filter layer have different light transmittances.

3. The camera device according to claim 1, wherein a light transmittance of the neutral density filter assembly is smaller than 15%.

4. The camera device according to claim 3, wherein the first neutral density filter layer has a light transmittance equal to or larger than 12%, and the second neutral density filter layer has a light transmittance equal to or larger than 12%.

5. The camera device according to claim 1, wherein the neutral density filter assembly has a first substrate, the first substrate has a first surface facing the optical unit and a second surface opposite to the first surface, and the first neutral density filter layer and the second neutral density filter layer are respectively disposed on the first surface and the second surface of the first substrate.

6. The camera device according to claim 1, wherein the neutral density filter assembly has a first substrate and a second substrate, the first substrate and the second substrate are arranged along the direction in which the light is transmitted, the first substrate has a first surface facing the optical unit and a second surface opposite to the first surface, the second substrate has a third surface facing the optical unit and a fourth surface opposite to the third surface, the first neutral density filter layer is disposed on one of the first surface and the second surface, and the second neutral density filter layer is disposed on one of the third surface and the fourth surface.

7. The camera device according to claim 6, wherein the first neutral density filter layer is located on the second surface of the first substrate, and the neutral density filter assembly further comprises an anti-reflective layer disposed on the first surface of the first substrate.

8. The camera device according to claim 6, wherein the second neutral density filter layer is located on the fourth surface of the second substrate, and the neutral density filter assembly further comprises an anti-reflective layer disposed on the third surface of the second substrate.

9. The camera device according to claim 6, wherein the first neutral density filter layer is located on the second surface of the first substrate, and the neutral density filter assembly further comprises a diamond-like carbon film disposed on the first surface of the first substrate.

10. The camera device according to claim 6, wherein the second neutral density filter layer is located on the fourth surface of the second substrate, and the neutral density filter assembly further comprises a diamond-like carbon film disposed on the third surface of the second substrate.

11. The camera device according to claim 1, further comprising a protection unit disposed between the light entrance and the neutral density filter assembly, wherein the protection unit has an anti-reflective layer disposed on a side of the protection unit facing the neutral density filter assembly.

12. The camera device according to claim 1, wherein the optical unit has a light entrance surface adjacent to the second neutral density filter layer, and the light entrance surface is configured to reflect a portion of the light and to allow another portion of the light to go through the second neutral density filter layer.

13. The camera device according to claim 12, wherein the light entrance surface is a curved surface.

14. The camera device according to claim 13, wherein the optical unit is a focusing lens.

15. The camera device according to claim 12, wherein a light transmittance of the second neutral density filter layer is larger than that of the first neutral density filter layer.
